(19) United States
(12) Patent Application Publication
(10) Pub. No.: US 2018/0009450 A1
(43) Pub. Date: Jan. 11, 2018

(54) System for Repositioning Weight in Response to Vehicle Speed

(71) Applicant: Thomas J. Shaw, Frisco, TX (US)

(72) Inventor: Thomas J. Shaw, Frisco, TX (US)

(21) Appl. No.: 15/637,164

(22) Filed: Jun. 29, 2017

Related U.S. Application Data
(60) Provisional application No. 62/358,412, filed on Jul. 5, 2016.

(51) Int. Cl. B61C 15/14; B61C 15/04; B60W 40/105; B65G 21/20

(52) U.S. Cl. CPC B61C 15/14; B61C 15/04; B60W 40/105; B65G 21/2081

(57) ABSTRACT

A system for repositioning at least one battery of an electric-powered vehicle relative to a drive axle of the vehicle to increase the weight carried by the axle as the vehicle attains a predetermined speed.

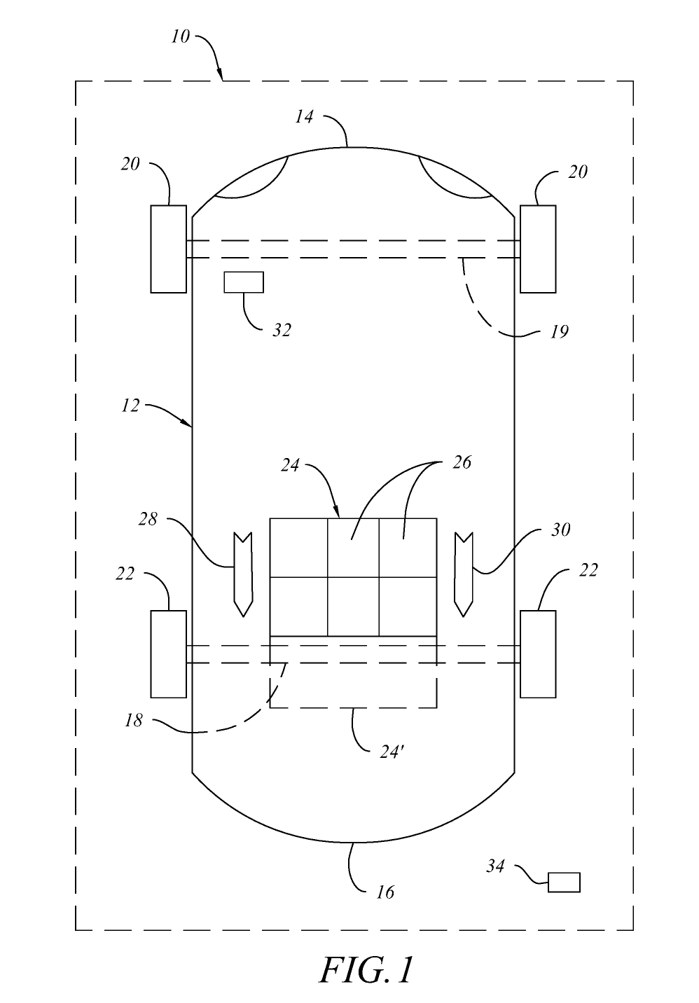

### 1. FIELD OF THE INVENTION

This invention relates to motor vehicles and, more particularly, to a system configured to reposition weight being transported by the motor vehicle so as to increase the amount of weight disposed over an axle to increase the downwardly directed force applied to an underlying road surface through drive wheels connected to the axle. The subject invention can be used, for example, to reposition batteries in electric-powered vehicles to apply more weight over the drive wheels as the vehicle gains speed to counteract aerodynamic lift experienced by the vehicle at higher speeds.

### 2. DESCRIPTION OF RELATED ART

Motor vehicle designers, manufacturers and operators have long recognized weight and body shape as being important elements of vehicle design in that they can significantly affect performance and fuel efficiency as well as contributing to vehicle safety and aesthetics-all of which are factors that consumers can consider in relation to price when making a vehicle purchase decision. Efforts of vehicle designers to reduce aerodynamic drag and increase fuel efficiency have led to the selection of vehicle body shapes that contribute to laminar air flow over and around the body, especially when the vehicle is operating at highway speeds or greater.

For these and other reasons, vehicle body designs often incorporate the use of “spoilers,” which can be configured in various ways and installed at various places to produce a desired aerodynamic effect that is dependent upon vehicle speed and the relative configurations of both the body and the spoiler. In general, smoothly contoured vehicle bodies characterized by smooth contours and low coefficients of aerodynamic drag tend to improve fuel efficiency but can also contribute to aerodynamic lift (like an airplane wing), the effects of which become more pronounced when the vehicle reaches higher speeds. This tendency can be even more pronounced where a spoiler disposed at the front of the vehicle is configured to channel additional air flow to an engine and/or to reduce the amount of air passing beneath the vehicle to reduce drag. As aerodynamic drag is reduced and the vehicle body experiences “lift,” traction between the wheels of the vehicle and an underlying road surface is lowered because of the reduced air pressure pressing downwardly on the vehicle body. This lowering of traction can become a serious safety hazard at higher speeds or when operating a vehicle over road surfaces that are themselves “loose” or covered wholly or in part by traction-reducing substances such as water, ice or mud.

Depending upon the contour of a vehicle body, rear deck spoilers can be used to smooth out the air flow over a turbulent zone created by a large drop-off angle that may exist behind the roof of the vehicle. In other vehicles, such as the Porsche 911® turbos, a rear deck spoiler configured as a “whale tail” has been used in the past to disrupt laminar air flow over the body, thereby reducing lift and increasing traction. More recently, high performance automobiles have sometimes been configured with spoilers that deploy to increase traction once the vehicle reaches a predetermined speed. By contrast, in open wheel racing cars, aerodynamic “wings” are often used as “air dams” to create additional downforce on a vehicle to help prevent it from becoming airborne during racing conditions. Because motor vehicle traction can often be improved by placing additional weight over the drive axle, particularly when the underlying surface upon which the motor vehicle is being operated is wet or slippery, motor vehicle operators have been urged in the past to place bags of sand, cement or other heavy items in the trunks or beds of rear-wheel drive passenger vehicles to improve tire traction when driving during wintery weather. Front-wheel drive vehicles are known to provide improved traction under adverse road conditions because the motor weight is already disposed over the front axles.

Various devices have previously been disclosed for use in applications such as balancing fuel between multiple wing tanks of aircraft; adjusting the hitch weight of towed trailers; repositioning liquid ballast in boats; repositioning aerodynamic skirts of semi-trailers (U.S. Pat. No. 8,678,474); and repositioning a movable weight in a counter-balancing system for a monorail (U.S. Pub. No. 2015/0353100). U.S. Pat. No. 9,133,865 discloses a position control apparatus configured to move at least one side guide component of a conveyor system to any of a plurality of component positions, as desired, within a component position range. U.S. Pat. No. 8,966,739 discloses a device and method for moving a load across the floor of a vehicle between a first position and a second position, the method including the steps of applying a load to the load bearing structure to disengage the surface-engaging assembly; applying a lateral force to the load bearing structure to move the device to the second position; and removing the load from the load bearing structure so that the surface engaging assembly returns to the engaged condition in the second position.

### SUMMARY OF THE INVENTION

One embodiment of this invention relates to motor vehicles and, more particularly, to motor vehicles configured to permit a vehicle operator to selectively reposition a portion of a load being transported by the motor vehicle so as to increase the amount of weight disposed over at least one selected axle to increase traction of wheels connected to the axle on an underlying road surface. Alternatively, a vehicular load repositioning system can be configured to automatically reposition or redistribute weight inside a vehicle in response to predetermined parameters and criteria as monitored by an electronic control unit (ECU) that is onboard the vehicle. If desired, predetermined operational data and parameters can be transmitted from a vehicle to a remotely situated control system that processes the transmitted data, computes solutions and instructions, and transmits the instructions back to an onboard ECU. Although not limited to use with electric-powered or hybrid vehicles typically having a plurality of batteries that contribute significantly to the weight of the vehicle, the present invention is believed to be particularly useful with such vehicles, and especially where such vehicles are able to accelerate rapidly and/or achieve higher speeds. One example of such a vehicle is a Tesla® Model S electric powered automobile that is reportedly able to accelerate from 0 to 60 miles per hour in 2.8 seconds.

### BRIEF DESCRIPTION OF THE DRAWINGS

The apparatus of the invention is further described and explained in relation to the accompanying drawing FIGURE, which is a simplified diagrammatic view of an embodiment of the system of the invention.

### DETAILED DESCRIPTION

The accompanying drawing discloses a satisfactory embodiment of system 10 of the invention as installed in relation to electric-powered automobile 12, which can be all-electric or can be a hybrid that also provides another source of motive energy to the vehicle. Automobile 12 further comprises front end 14, rear end 16, front axle 19, rear axle 18, front wheels 20 and rear wheels 22. In this embodiment of the invention, automobile 12 is a rear-wheel drive vehicle, meaning that axle 18 is the drive axle and wheels 22 are the driven wheels. A frame 24 supports a plurality of batteries 26 in a first position at shown in solid outline and can be either selectively or automatically moved to a second position 24′ to cause drive axle 18 to carry more weight and increase traction between rear wheels 22 and an underlying surface.

According to one satisfactory embodiment of the invention, electronic control unit (ECU) 32 receives and monitors data input representative of one or more parameters such as the speed of automobile 12 relative to an underlying surface, and signals a repositioning mechanism operably connected to frame 24 to move the plurality of batteries 26 rearwardly relative to drive axle 18 as indicated by rearwardly point arrows 28, 30 whenever a predetermined vehicle speed is reached or whenever any other predetermined set of operational criteria is satisfied that would indicate the desirability of moving the battery weight rearwardly. Alternatively, the repositioning mechanism can be activated in response to operator input if desired. In the latter situation, the operator input can originate with the driver or can originate from a remote source 34 that communicates electronically with electronic control unit 32 of another driver interface.

In should also be understood and appreciated that system 10 as described above can also be configured to move frame 24 and batteries 26 to multiple intermediate positions and, if desired, to reposition frame 24 and batteries 26 to one or more positions in the opposite direction to further modify the weight carried by drive axle 18 and move the center of gravity of automobile 12 in other operational circumstances where such redistribution of the carried load may be desirable.

Any suitable repositioning mechanism can be used to reposition frame 24 and batteries 26. The repositioning mechanism will desirably include a switch or controller to initiate movement by an actuator to cause movement of frame 24 and batteries 26 relative to drive axle 18. The actuator can optionally include one or more drive elements including, for example, small electric motors, push rods driven by hydraulic, electrical or electromagnetic energy, springs, cables, scissor mechanisms, tracks, rollers or the like. One or more position sensors or counters are also desirably included in the repositioning mechanism to provide feedback to the ECU or operator as to how far frame 24 and batteries 26 have moved at any given time. System 10 can also be configured to move batteries 26 either backward or forward to adapt to changing operational parameters during use of automobile 12.

Where both front axle 19 and rear axle 18 are configured as drive axles, more than one frame 24 or other carrier can be provided, in conjunction with which either one or a plurality of batteries 26 can be automatically or selectively repositioned to place more or less battery weight over one or both axles at any given time in response to operational parameters making such movement desirable. In some configurations where a plurality of batteries are divided in to two or more groups, the controls and repositioning mechanisms can be designed to be shared or separate, although it will be appreciated that the repositioning mechanisms may need to be able to move different battery groups in opposite directions at the same time.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor(s) and/or Applicant are legally entitled.

What is claimed is:

1. In an automobile having a plurality of batteries, the improvement comprising a system configured to reposition at least one battery relative to an axle to increase the weight carried by the axle as the vehicle attains a predetermined speed.

2. The system of claim 1 wherein the automobile is driven by electricity.

3. The system of claim 1 wherein the automobile is a hybrid having the capability to be powered by electricity or, alternatively, by an internal combustion engine.

4. The system of claim 1 configured to reposition at least a portion of the batteries automatically when the vehicle attains a predetermined speed.

5. The system of claim 1 configured to reposition at least a portion of the batteries in response to an input by a driver.

6. The system of claim 1 wherein the at least one battery is repositioned by at least one electric motor.

7. The system of claim 1 wherein the at least one battery is repositioned by a hydraulic actuator.

8. The system of claim 1 wherein the at least one battery is repositioned by an electromagnetic actuator.

9. The system of claim 1 wherein the at least one battery is disposed on a movable frame.

10. The system of claim 1 wherein the at least one battery is movable on at least one track.

11. The system of claim 1 configured to reposition the at least one battery in response to an input received from a remote location.

12. The system of claim 1 wherein repositioning the at least one battery increases traction between at least one wheel attached to the axle and an underlying roadway.

13. The system of claim 1 wherein the axle is a drive axle.

14. A driver-interactive system comprising a first device configured to. selectively reposition at least one battery disposed in an electric-powered motor vehicle and a second device configured to actuate the first device in response to an input related to the speed of the vehicle.

15. The driver-interactive system of claim 14 wherein the electric-powered motor vehicle comprises at least one drive axle and at least one wheel connected to the at least one drive axle, and wherein the first device repositions the battery relative to the at least one drive axle so as to adjust the weight carried by the at least one drive axle in response to an input related to the speed of the vehicle.

16. The driver-interactive system of claim 14 wherein the second device is an electronic controller disposed on board the electric-powered motor vehicle.

17. The driver-interactive system of claim 16 wherein the electronic controller can be operated by the driver to selectively reposition the at least one battery relative to the at least one axle to increase the total weight carried by the axle in response to operating parameters communicated to the driver.

18. The driver-interactive system of claim 14 wherein at least one of the first device and the second device is a controller disposed on board the electric-powered motor vehicle, which controller can be operated by the driver to selectively reposition the at least one battery relative to the at least one axle to decrease the total weight carried by the axle in response to operating parameters communicated to the driver.

19. The driver-interactive system of claim 14 wherein the electric-powered motor vehicle is all electric.
